(19) United States
(12) Patent Application Publication
(10) Pub. No.: US 2022/0228713 A1
(43) Pub. Date: Jul. 21, 2022

(54) HYDROGEN STORAGE TANK WITH LEAK MANAGEMENT FUNCTIONALITY

(71) Applicant: ROLLS-ROYCE plc, London (GB)

(72) Inventors: Philip D. BUTLER, Ashbourne (GB); Eric W. DEAN, Derby (GB); Chloe J. PALMER, Derby (GB)

(73) Assignee: ROLLS-ROYCE plc, London (GB)

(21) Appl. No.: 17/556,211

(22) Filed: Dec. 20, 2021

(30) Foreign Application Priority Data
Jan. 19, 2021 (GB) 2100662.2

(51) Int. Cl. F17C 1/16; F17C 13/02; H01M 8/04089; H01M 8/04746; H01M 8/04111

(52) U.S. Cl. CPC F17C 1/16; H01M 2250/20; H01M 8/04089; H01M 8/04753; H01M 8/04111; F17C 2221/012; F17C 2203/066; F17C 2201/0109; F17C 2203/012; F17C 2250/0443; F17C 2270/0184; F17C 2227/0157; F17C 2270/0189; F17C 2203/0624; F17C 2203/0663; F17C 2260/042; F17C 13/02

(57) ABSTRACT

A hydrogen storage tank has a composite laminate wall, a hydrogen-porous layer in contact with the outer surface of the composite laminate wall and a hydrogen-non-porous layer in contact with the outer surface of the hydrogen-porous layer, the hydrogen-non-porous layer having an output port for venting hydrogen which passes through the composite laminate wall and the hydrogen-porous layer from the interior of the tank. The tank allows hydrogen which leaks through the composite laminate wall to be collected and re-used. The invention also allows for the rate of hydrogen leakage from the tank to be measured, providing a measure of the structural integrity of the tank.

### CROSS-REFERENCE TO RELATED PATENT APPLICATIONS

This application is based upon and claims the benefit of priority from British Patent Application No. GB 2100662.2, filed on Jan. 19, 2021, the entire contents of which are herein incorporated by reference.

### BACKGROUND

### Technical Field

The present disclosure relates to storage of gaseous hydrogen, particularly for use in transport applications, including aeronautical applications.

### Description of Related Art

The use of gaseous hydrogen as a fuel is of increasing interest in transport applications, including aeronautical applications, due an absence of CO₂ generation at the point of use. However, storage of gaseous hydrogen in a storage tank presents several technical challenges, one of which is the management of hydrogen which leaks from the tank. Leakage of gaseous hydrogen from hydrogen storage tanks is common, due to the very small size of the hydrogen molecule (120 pm). Loss of hydrogen by leakage wastes fuel, presents an explosion risk, particularly where a tank is located in a enclosed area, and may also lead to degradation of metallic parts by embrittlement.

### SUMMARY

According to an example, a hydrogen storage tank has a composite laminate wall, a hydrogen-porous layer in contact with the outer surface of the composite laminate wall and a hydrogen-non-porous layer in contact with the outer surface of the hydrogen-porous layer, the hydrogen-non-porous layer having an output port for venting hydrogen which passes through the composite laminate wall and the hydrogen-porous layer from the interior of the tank. The hydrogen storage tank allows gaseous hydrogen which leaks from the tank to be collected, thus avoiding potential explosion and/or embrittlement of metal parts. Collected hydrogen may be used, for example in a fuel cell or gas turbine engine, rather than simply being wasted. The hydrogen-non-porous layer is non-porous to hydrogen which leaks through the composite laminate wall of the tank.

The hydrogen-porous layer may comprise open-cell foam or may consist of an open-cell foam layer. Alternatively, the hydrogen-porous layer may be a layer of fibrous material.

The hydrogen-non-porous layer may be layer of rubber-based or polymeric material or alternatively a closed-cell foam layer.

Preferably the hydrogen-non-porous layer is separable from the hydrogen-porous layer and replaceable.

The hydrogen-non-porous layer is preferably permanently mechanically deformable so that a history of impacts experienced by the tank may be recorded over time; such a history gives an indication of the likely current structural condition of the tank.

The tank may be generally cylindrical and may comprise a plurality of impact-protecting ribs on the exterior of the tank, the ribs extending azimuthally and/or longitudinally with respect to the central longitudinal axis of the tank. The ribs may be integral with the hydrogen-non-porous layer, or applied to it. The ribs provide the tank with impact protection.

According to another example, apparatus comprises a hydrogen storage tank as described above and a measuring system for measuring the flow rate of hydrogen passing through the output port of the hydrogen storage tank. The flow rate and/or its rate of change may be used to infer the structural condition of the tank.

According to a further example, apparatus comprises a hydrogen storage tank as described above, a hydrogen-fueled fuel cell or a hydrogen-fueled gas turbine engine and a conveying system arranged to convey hydrogen from the output port of the tank to the fuel cell or gas turbine engine. The apparatus provides for hydrogen which leaks from the hydrogen storage tank to be used in the fuel cell or gas turbine engine rather than simply wasted. A measuring system may be provided for measuring the flow rate of hydrogen within the conveying system. The apparatus may comprise a compressor arranged to increase the pressure of hydrogen within the conveying system prior to its delivery to the fuel cell or gas turbine engine.

According to a further example, an aircraft comprises apparatus as described above.

### BRIEF DESCRIPTION OF THE DRAWINGS

Examples are described below with reference to the accompanying drawings in which:

FIG. 1 is a side view of a first example tank;

FIG. 2 is longitudinal cross-section through a portion of the wall of the FIG. 1 tank in a plane which includes the central longitudinal axis of the tank; and

FIG. 3 is a longitudinal cross-section through a portion of the wall of a second example tank in a plane which includes the central longitudinal axis of the tank.

### DETAILED DESCRIPTION

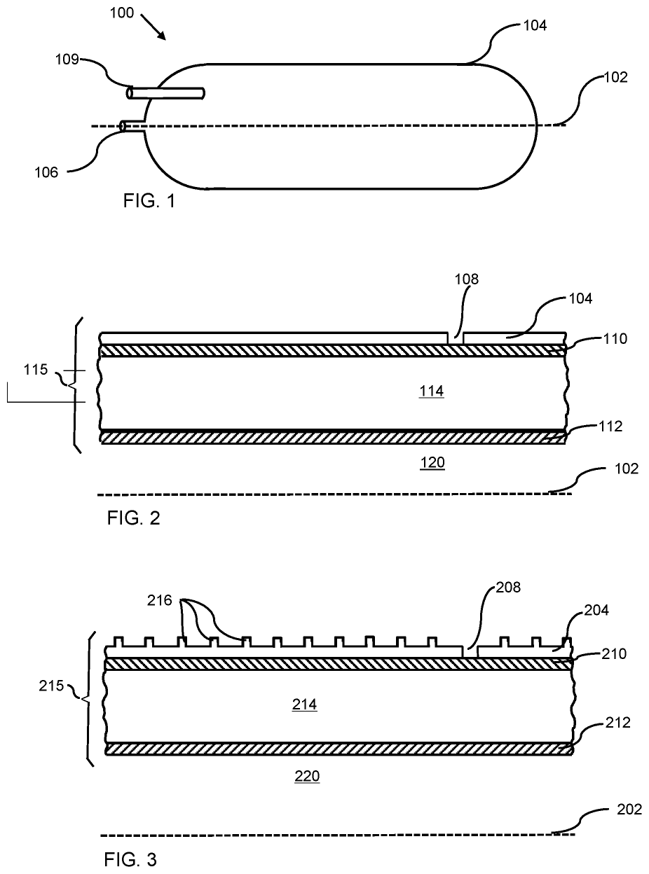

Referring to FIGS. 1 and 2, a first example hydrogen storage tank 100 has a generally cylindrical body with hemispherical domed ends, one domed end having main fuel port 106 allowing an internal storage volume 120 of the tank 100 to be filled with gaseous hydrogen and discharged. The tank 100 has a central longitudinal axis 102. The wall 115 of the tank 100 comprises a polymer liner 112, a composite laminate wall 114, a hydrogen-porous layer 110 in contact with the outer surface of the composite laminate wall 114 and a hydrogen-non-porous layer 104 in contact with the outer surface of the hydrogen-porous layer 110. The hydrogen-non-porous layer 104 allows hydrogen which leaks from the internal storage volume 120 through the liner 112, composite laminate wall 114 and hydrogen-porous layer 110 to be captured and removed via an output port 108 in the hydrogen-non-porous layer 104. A conduit 109 couples to the output port 108 to the exterior of the tank 100.

The conduit 109 may be connected by a conveying system to a second hydrogen storage tank for collection of hydrogen which has leaked from storage volume 120 of the tank 100. Alternatively, the conveying system may transfer hydrogen which has leaked from the tank 100 to a PEM fuel cell or a hydrogen-burning gas turbine engine. The conveying system may include a flow meter for measuring the rate at which hydrogen leaks from the tank 100. Where the conveying means is arranged to transport hydrogen from the conduit 109 to a fuel-cell or gas turbine engine, a compressor may be used increase the pressure of the hydrogen prior to its input to the fuel-cell or gas turbine engine. Measurements over time of the flow rate of hydrogen leaking from the internal storage volume 120 of the tank 100 through the output port 108 may be used to detect degradation of the composite laminate wall 114, for example by micro-cracking or de-lamination. A high rate of leakage compared to the rate of leakage when the tank 100 is first brought into service, or a sudden increase in the rate of leakage, may indicate imminent failure of the tank 100, allowing for its timely replacement.

The hydrogen storage tank 100 is a so-called ‘Type IV’ tank due to the presence of the polymer liner 112, however in a variant tank the liner 112 may be omitted so that the variant tank is a so-called ‘Type V’ tank.

The hydrogen-porous layer 110 may be an open-cell foam layer or may comprise open-cell foam. Preferably the layer 104 is permanently mechanically deformable, allowing impacts experienced by the tank 100 to be recorded. The mechanical integrity of the tank 100 may be inferred at least in part from a history of impacts experienced by the tank 100. Alternatively, the hydrogen-porous layer 110 may be a layer of fibrous material.

The hydrogen-non-porous layer 104 may be a flexible rubber-based or polymeric layer, since the layer 104 is only required to contain leaked hydrogen at approximately atmospheric pressure rather than at the pressure within the internal storage volume 120 of the tank 100. The hydrogen-non-porous layer 104 may alternatively be a layer of closed-cell foam material.

The hydrogen-non-porous layer 104 may be separable from the hydrogen-porous layer 110 and replaceable since it is the outer layer of the tank 100. The layer 104 can be tested to ensure its gas-tightness by applying a small positive pressure to the port 108 and monitoring its decay over time.

FIG. 3 shows a longitudinal cross-section through a portion of the wall 215 of a second generally cylindrical example hydrogen storage tank, the cross-section including the central longitudinal axis 202 of the tank. The wall 215 of the second example tank has a structure similar to that of the wall 115 of the tank 100 of FIGS. 1 and 2; parts in FIG. 3 which correspond to parts in FIG. 2 are labelled with reference numerals differing by 100 from those labelling the corresponding parts in FIG. 2. The hydrogen-non-porous layer 214 has a plurality of ribs 216 each of which extends azimuthally with respect to the central longitudinal axis 202 of the tank. The ribs 216 provide impact protection for parts of the wall 215 disposed radially inwardly of the layer 214. In a variant of the second example tank, a series of longitudinal ribs, each extending parallel to the central longitudinal axis 202 of the tank, are formed integrally with the layer 214 and distributed in azimuth around periphery of tank.

In other variants of the second example tank, azimuthal and/or longitudinal ribs may be applied to the outer surface of the hydrogen-non-porous layer rather than being formed integrally with it.

What is claimed is:

1. A hydrogen storage tank having a composite laminate wall, a hydrogen-porous layer in contact with the outer surface of the composite laminate wall and a hydrogen-non-porous layer in contact with the outer surface of the hydrogen-porous layer, the hydrogen-non-porous layer having an output port for venting hydrogen which passes through the composite laminate wall and the hydrogen-porous layer from the interior of the tank.

2. A hydrogen storage tank according to claim 1, wherein the hydrogen-porous layer comprises open-cell foam or consists of an open-cell foam layer.

3. A hydrogen storage tank according to claim 1, wherein the hydrogen-porous layer is a layer of fibrous material.

4. A hydrogen storage tank according to claim 1, wherein the hydrogen-non-porous layer is a rubber-based or polymeric layer.

5. A hydrogen storage tank according to claim 1, wherein the hydrogen-non-porous layer is a closed-cell foam layer.

6. A hydrogen storage tank according to claim 1, wherein the hydrogen-non-porous layer is separable from the hydrogen-porous layer and replaceable.

7. A hydrogen storage tank according to claim 1, wherein the hydrogen-porous layer is permanently mechanically deformable.

8. A hydrogen storage tank according to claim 1, the tank being generally cylindrical and comprising a plurality of impact-protecting ribs on the exterior of the tank, the ribs extending azimuthally and/or longitudinally with respect to the central longitudinal axis of the tank.

9. A hydrogen storage tank according to claim 8, wherein the ribs are integral with the hydrogen-non-porous layer.

10. A hydrogen storage tank according to claim 8, wherein the ribs are applied to the exterior of the tank.

11. Apparatus comprising a hydrogen storage tank according to claim 1, and a measuring system for measuring the flow rate of hydrogen passing through the output port of the hydrogen storage tank.

12. Apparatus comprising a hydrogen storage tank according to claim 1, a hydrogen-fueled fuel cell or a hydrogen-fueled gas turbine engine and a conveying system arranged to convey hydrogen from the output port of the tank to the fuel cell or gas turbine engine.

13. Apparatus according to claim 12, comprising means for measuring the flow rate of hydrogen within the conveying system.

14. Apparatus according to claim 12, further comprising a compressor arranged to compress hydrogen within the conveying system prior to delivery of the hydrogen to the fuel cell or gas turbine engine.

15. An aircraft comprising a hydrogen storage tank according to claim 1.

16. An aircraft comprising apparatus according to claim 12.
